(19) United States
(12) Patent Application Publication
(10) Pub. No.: US 2003/0033935 A1
(43) Pub. Date: Feb. 20, 2003

(54) Air filter with laminated polytetrafluoroethylene membranes

(76) Inventor: Yen-Jung Hu, Hsinchu City (TW)

Correspondence Address: OSTROLENK FABER GERB & SOFFEN, 1180 AVENUE OF THE AMERICAS, NEW YORK, NY, 100368403

(21) Appl. No.: 09/933,418

(22) Filed: Aug. 20, 2001

(51) Int. Cl. B01D 53/22

(52) U.S. Cl. 96/11

(57) ABSTRACT

An air filter includes at least a laminate having porous first and second polytetrafluoroethylene membranes and an air-permeable supporting member that is sandwiched between and that is bonded to the first and second polytetrafluoroethylene membranes.

### BACKGROUND OF THE INVENTION

1. Field of the Invention

This invention relates to an air filter having laminated porous polytetrafluoroethylene membranes.

2. Description of the Related Art

FIG. 1 illustrates a conventional high performance air filter which includes a polytetrafluoroethylene (PTFE) membrane 12 laminated with a supporting member 11. The air filter is particularly useful for collecting suspended particles in a clean room. Performance of the air filter can be expressed by collecting efficiency and pressure drop. The collecting efficiency of the air filter is defined as percentage of the number of removed particles divided by the total number of particles prior to filtration. While exhibiting high collecting efficiency (greater than 99.99%), the pressure drop of the conventional air filter is relatively high, which, in turn, results in a decrease in air flow rate during operation.

### SUMMARY OF THE INVENTION

Therefore, it is an object of the present invention to provide an air filter for collecting suspended fine particles in a clean room that is capable of overcoming the aforementioned drawback.

According to the present invention, there is provided an air filter for collecting suspended fine particles in a clean room. The air filter comprises at least a laminate including porous first and second polytetrafluoroethylene membranes and an air-permeable supporting member that is sandwiched between and that is bonded to the first and second polytetrafluoroethylene membranes.

### BRIEF DESCRIPTION OF THE DRAWINGS

In drawings which illustrate embodiments of the invention,

FIG. 1 is a cross-sectional side view of a conventional air filter;

FIG. 2 is a cross-sectional side view illustrating a first preferred embodiment of an air filter of this invention;

FIG. 3 is a cross-sectional side view illustrating a second preferred embodiment modified from the air filter of FIG. 2; and

FIG. 4 is a cross-sectional side view illustrating a third preferred embodiment modified from the air filter of FIG. 2.

### DETAILED DESCRIPTION OF THE PREFERRED EMBODIMENTS

FIG. 2 illustrates a first preferred embodiment of an air filter of this invention for collecting suspended particles in a clean room. The air filter includes a laminate that has porous first and second filtering membranes 3 and an air-permeable supporting member 2 which is sandwiched between and which is bonded to the first and second filtering membranes 3.

The first and second filtering membranes 3 can be made from a material selected from a group consisting of polytetrafluoroethylene (PTFE), glass fiber paper, and melt blown non-woven fabric. Preferably, the first and second filtering membranes 3 are polytetrafluoroethylene membranes.

The air-permeable supporting member 2 is preferably a non-woven fabric that is made from a material selected from a group consisting of polyethylene, polypropylene, polyamides, polyesters, aromatic polyamides, and composite materials thereof. Preferably, the non-woven fabric is made from a composite material of two fibrous materials having different melting points. Preferably, the two fibrous materials are respectively polyethylene terephthalate and modified polyethylene terephthalate.

The laminate of the air filter of FIG. 2 is prepared by hot pressing the first and second filtering membranes 3 and the supporting member 2. In case the supporting member 2 is made from the composite material, the fibrous material having the lower melting point is fused, thereby causing the filtering membranes 3 to be bonded to the supporting member 2.

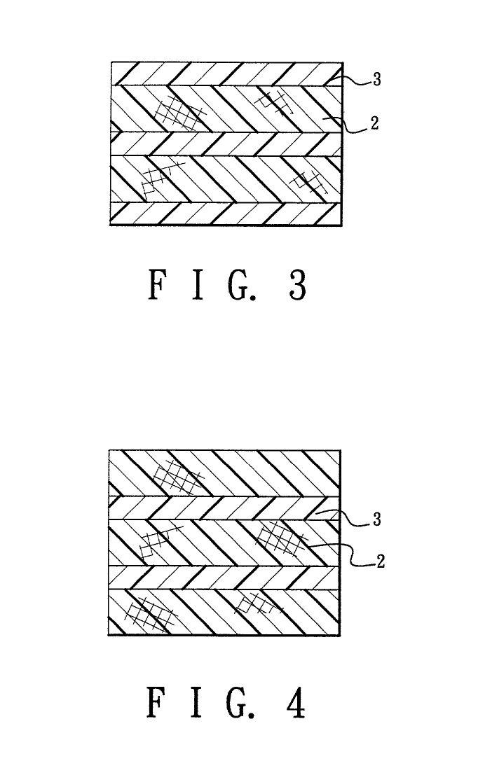

FIGS. 3 and 4 respectively illustrate second and third preferred embodiments of this invention. The laminate of the air filter of this invention can include a plurality of filtering membranes 3 and supporting members 2 alternately laminated to each other, as best illustrated in FIGS. 3 and 4.

The following Example and Comparative Example illustrate the advantages of the air filter of this invention as compared to those of conventional air filters.

### EXAMPLE 1

Two polytetrafluoroethylene membranes, each of which has a collecting efficiency of 99.69%, and a supporting member 2 made of the composite material of polyethylene terephthalate and modified polyethylene terephthalate were laminated to form the air filter of FIG. 2. The air filter was subjected to performance test to measure the collecting efficiency and the pressure drop thereof by passing therethrough an air stream that contains 0.26 micron NaCl particles. The air stream was kept at a constant flow rate of 5.3 cm/s (32 liters/min). The resulting values of the collecting efficiency and the pressure drop are respectively 99.999% and 27 mmH₂O.

### COMPARATIVE EXAMPLE 1

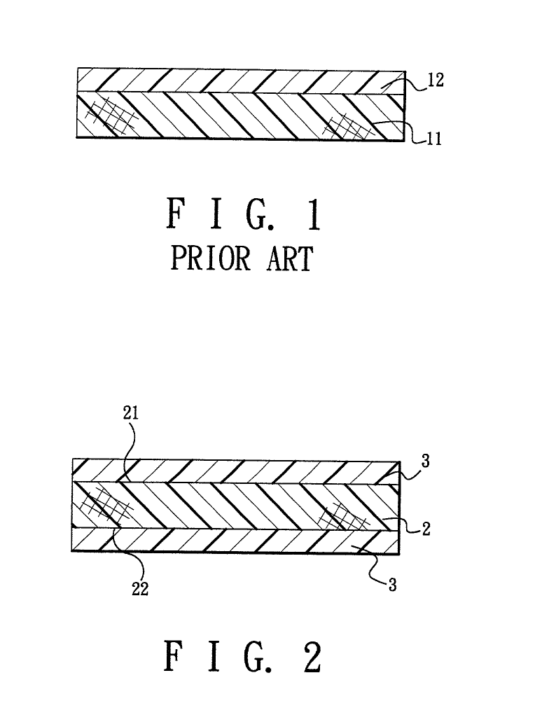

A conventional air filter of FIG. 1 was prepared in this Example. The polytetrafluoroethylene membrane employed in this conventional air filter has a collecting efficiency higher than that of the polytetrafluoroethylene membrane employed in the aforesaid Example 1. Conditions for measuring the collecting efficiency and the pressure drop of this conventional air filter were the same as those in Example 1. The resulting values of the collecting efficiency and the pressure drop were respectively 99.996% and 148 mmH₂O.

Comparison between the Example 1 and the comparative Example 1 shows that with two PTFE membranes, each of which has a lower collecting efficiency than that of the PTFE membrane of the conventional air filter, the overall collecting efficiency of the air filter in Example 1 can reach up to 99.999% as compared to 99.996% for the conventional air filter, while the overall pressure drop of the air filter can be significantly reduced to 27 mmH₂O. It is herein proposed that by maintaining the same overall collecting efficiency, the overall pressure drop can be significantly reduced for the air filter that has a greater number of PTFE membranes, each of which has a lower collecting efficiency.

With the invention thus explained, it is apparent that various modifications and variations can be made without departing from the spirit of the present invention.

I claim:

1. An air filter for collecting suspended fine particles in a clean room, said air filter comprising:
at least a laminate including porous first and second polytetrafluoroethylene membranes and an air-permeable supporting member that is sandwiched between and that is bonded to said first and second polytetrafluoroethylene membranes.

2. The air filter of claim 1, wherein said air-permeable supporting member is a non-woven fabric.

3. The air filter of claim 2, wherein said non-woven fabric is made from a material selected from a group consisting of polyethylene, polypropylene, polyamides, polyesters, aromatic polyamides, and composite materials thereof.

4. The air filter of claim 2, wherein said non-woven fabric is made from a composite material of polyethylene terephthalate and modified polyethylene terephthalate.
